(19) United States
(12) Patent Application Publication
(10) Pub. No.: US 2011/0282887 A1
(43) Pub. Date: Nov. 17, 2011

(54) SYSTEM AND METHOD FOR DATA MANAGEMENT OF A COMMUNICATION DEVICE

(75) Inventors: TZU-CHENG YU, Santa Clara, CA (US); JIING-RENN YU, Tu-Cheng (TW); YU-SHENG HOU, Tu-Cheng (TW); BOR-CHUAN LIN, Tu-Cheng (TW); JIAN-CHENG LIN, Tu-Cheng (TW); EL-HINN ELIZABETH, Tu-Cheng (TW); PEI-HSI CHENG, Tu-Cheng (TW); HUNG-CHANG WEI, Tu-Cheng (TW); YUN-JU CHEN, Tu-Cheng (TW); PEI-JU CHEN, Tu-Cheng (TW)

(73) Assignee: CHI MEI COMMUNICATION SYSTEMS, INC., Tu-Cheng City (TW)

(21) Appl. No.: 12/871,949

(22) Filed: Aug. 31, 2010

(30) Foreign Application Priority Data
May 11, 2010 (TW) 99114874

(51) Int. Cl. G06F 17/30

(52) U.S. Cl. 707/752; 707/E17.044

(57) ABSTRACT

A communication device and a method for data management include setting a birth month and a birth day of each contact in a contact list. The method further includes arranging all the contacts in the contact list according to the birth month of each contact, and arranging contacts having the same birth month according to the birth day of each contact sharing the same month.

### BACKGROUND

1. Technical Field

Embodiments of the present disclosure relate to communication devices, and in particular, to a system and method for data management of a communication device.

2. Description of Related Art

Many popularly used communication devices, such as mobile phones, provide organization of user information, such as contacts. Often, such information is sorted into one preset order and cannot be rearranged according to user requirements.

### BRIEF DESCRIPTION OF THE DRAWINGS

FIG. 1 is a block diagram of one embodiment of a communication device including a management system.

FIG. 2 is a block diagram of one embodiment of the management system of FIG. 1.

FIG. 3 is a schematic diagram of one embodiment of the management system of FIG. 1.

FIG. 4 is a flowchart of one embodiment of a method for data management of a communication device, such as, for example, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system.

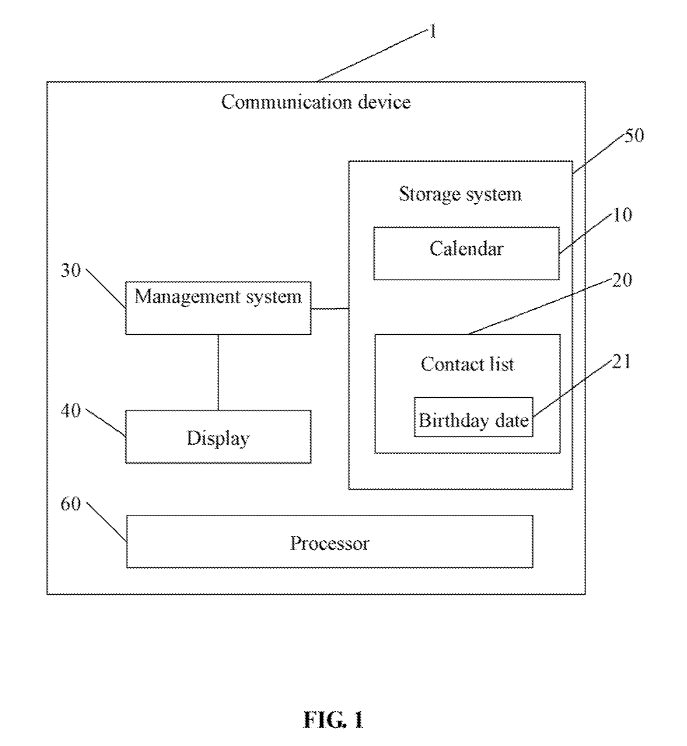

FIG. 1 is a block diagram of one embodiment of a communication device 1 including a management system 30. The communication device 1 includes a storage system 50, which may store a calendar 10 and a contact list 20. The management system 30 may rearrange contacts in the contact list 20 according to birthday information of the contacts. The calendar 10 may provide time information.

The contact list 20 includes contact information of the contacts, such as phone numbers and addresses, for example. The contact list 20 further includes a birth date 21. The recording format of the birth date 21 may be month/day. For example, if the birth date of a contact is March 14, the birth data in the birth date 21 is represented as “03-14”. The storage system 50 may be a memory system of the communication device 1, and also may be an external storage card, such as a smart media (SM) card, or secure digital (SD) card, for example.

The communication device 1 further includes a display 40 and a processor 60. The display 40 may output visible data, such as images or the contact information, for example. The processor 60 executes one or more computerized code of the communication device 1 and other applications, to provide the functions of the communication device 1.

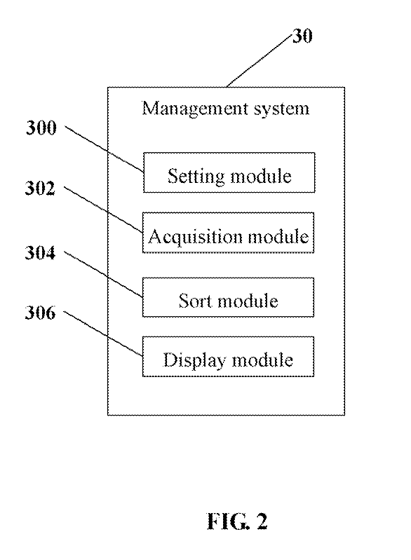

FIG. 2 is a block diagram of one embodiment of the management system 30 of FIG. 1. In some embodiments, the management system 30 includes a setting module 300, an acquisition module 302, a sort module 304, and a display module 306. The modules 300-306 may comprise computerized code in the form of one or more programs that are stored in the storage system 50. The computerized code includes instructions that are executed by the at least one processor 60 to provide functions for modules 300-306. Details of these operations follow.

The setting module 300 sets a birth date 21 for each contact in the contact list 20, and stores information of the birth date 21 in a predetermined recording format into the storage system 50. In some embodiments, the birth date 21 includes a birth month and a birth day, and the recording format may be recorded as month/day.

The acquisition module 302 obtains birth dates including the birth month and the birth day of each contact from the birth date 21.

The arranging module 304 arranges all the contacts in the contact list 20 according to the birth month of each contact, and arranges contacts in the contact list 20 having the same birth month according to the birth day of each of the contacts having the same birth month. In some embodiments, the contacts may be arranged in order from January to December, and contacts having the same birth month may be arranged according to the birth day in an order from 1 to 31.

The acquisition module 302 further determines a current month from the calendar 10.

The display module 306 rearranges the contacts with birth months matching the current month ahead of contacts (e.g., in front of or behind) with birth months different from the current month. The display module 306 further shows the rearranged contacts in the contact list 20 on the display 40. In some embodiments, the display module 306 may further rearrange the other contacts with birth months other than the current month according to the birth month and the birth day. Detailed descriptions follow.

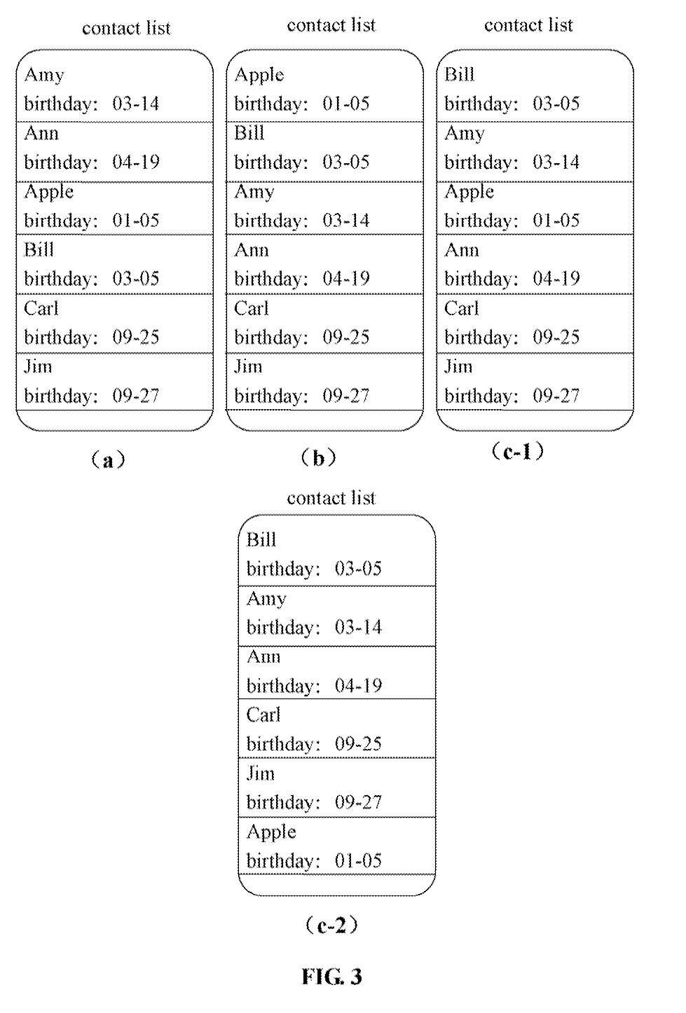

FIG. 3 is a schematic diagram of one embodiment of the management system of FIG. 1. As shown in FIG. 3(a), the setting module 300 sets each birth date 21 of the contact list 20. The acquisition module 302 obtains birth date including birth month and birth day of each contact from the birth date 21.

As shown in FIG. 3(b), the arranging module 304 arranges all the contacts in the contact list 20 according to the birth month of each contact, and arranges contacts having the same birth month according to the birth day of each of the contacts having the same birth month. The acquisition module 302 determines that the current month from the calendar 10 is March. In the contact list 20, birth months of “Bill” and “Amy” are March.

As shown in FIG. 3(c-1), the display module 306 rearranges the contacts “Bill” and “Amy” with birth months March ahead of the other contacts with birth months not March, and maintains them, still according to the birth month and the birth day.

As shown in FIG. 3(c-2), the display module 306 rearranges the contacts with birth months not March according to an order of the birth month from April to February. In other embodiments, the contacts of contact list 10 may be shown in other display modes.

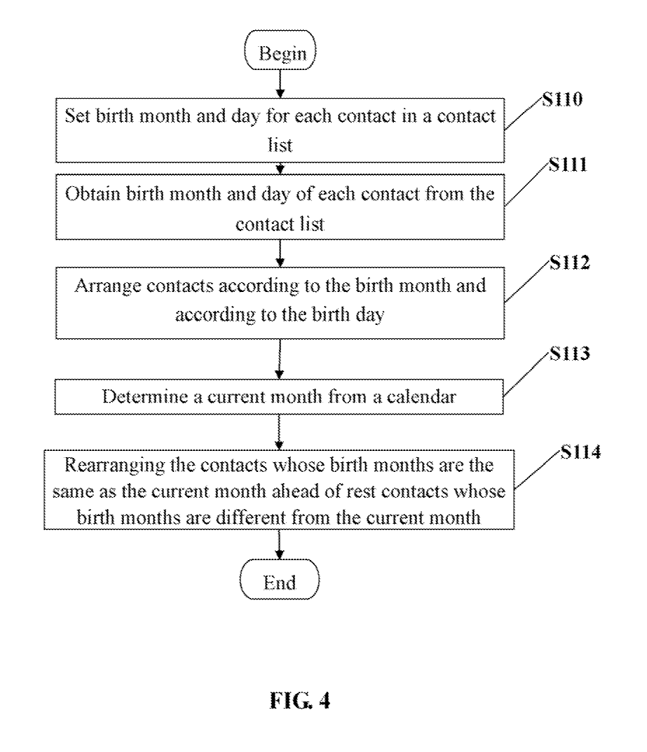

FIG. 4 is a flowchart of one embodiment of a method for data management using a communication device such as, for example, that of FIG. 1. Depending on the embodiment, additional blocks may be added, others removed, and the ordering of the blocks may be changed.

In block S110, the setting module 300 sets a birth date 21 for each contact of the contact list 20, and stores information of the birth date 21 in a predetermined recording format into the storage system 50. The birth date includes birth month and birth day, and the recording format may be recorded as month/day.

In block S111, the acquisition module 302 obtains birth dates including the birth month and the birth day of each contact from the birth date 21.

In block S112, the arranging module 304 arranges all the contacts in the contact list 20 according to the birth month of each contact, and arranges contacts having the same birth month according to the birth day of each of the contacts having the same birth month.

In block S113, the acquisition module 302 further determines a current month from the calendar 10.

In block S114, the display module 306 rearranges the contacts with birth months matching the current month ahead of the other contacts with birth months different from the current month. The display module 306 further displays the rearranged contacts in the contact list 20 on the display 40. The display module 306 further maintains the other contacts with birth months different from the current month according to the birth month and the birth day.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be comprised herein within the scope of this disclosure and the above-described inventive embodiments, and the present disclosure is protected by the following claims.

What is claimed is:

1. A communication device, comprising:
a storage system storing a calendar and a contact list;
a display;
at least one processor; and
one or more programs that are stored in the storage system and are executed by the at least one processor, the one or more programs comprising instructions:
to set a birth date of each contact in the contact list, the birth date comprising a birth month and a birth day of the each contact;
to arrange all the contacts in the contact list according to the birth month of each of the contacts, and arrange contacts having the same birth month according to the birth day of each of the contacts having the same birth month.

2. The communication device as claimed in claim 1, wherein the one or more programs further comprise instructions:
to determine a current month from the calendar.

3. The communication device as claimed in claim 2, wherein the one or more programs further comprise instructions:
to rearrange the contacts with birth months matching the current month ahead of the other contacts with birth months different from the current month, and display the rearranged contacts in the contact list on the display.

4. The communication device as claimed in claim 3, wherein the one or more programs further comprise instructions:
to maintain the other contacts with birth months different from the current month still according to the birth month and the birth day.

5. The communication device as claimed in claim 1, wherein the birth date of each contact in the contact list in recorded in a format of month/day.

6. A computer-implemented method for data management of a communication device, the communication device comprising a calendar and a contact list, the method comprising:
setting a birth date of each contact in the contact list, the birth date comprising a birth month and a birth day of the each contact;
arranging all the contacts in the contact list according to the birth month of each of the contacts, and arrange contacts having the same birth month according to the birth day of each of the contacts having the same birth month.

7. The method as claimed in claim 6, further comprising determining a current month from the calendar.

8. The method as claimed in claim 7, further comprising rearranging the contacts with birth months matching the current month ahead of the other contacts with birth months different from the current month, and showing the rearranged contacts in the contact list on a display of the communication device.

9. The method as claimed in claim 8, further comprising maintaining the other contacts with birth months different from the current month still according to the birth month and the birth day.

10. The method as claimed in claim 6, wherein the birth date of each contact in the contact list in recorded in a format of month/day.

11. A storage medium storing a set of instructions, the set of instructions capable of being executed by a processor to perform a method of data management of a communication device, the communication device comprising a calendar and a contact list, the method comprising:
setting a birth date of each contact in the contact list, the birth date comprising a birth month and a birth day of the each contact;
arranging all the contacts in the contact list according to the birth month of each of the contacts, and arrange contacts having the same birth month according to the birth day of each of the contacts having the same birth month.

12. The storage medium as claimed in claim 11, further comprising determining a current month from the calendar.

13. The storage medium as claimed in claim 12, further comprising rearranging the contacts with birth months matching the current month ahead of the other contacts with birth months different from the current month, and showing the rearranged contacts in the contact list on a display of the communication device.

14. The storage medium as claimed in claim 13, further comprising maintaining the other contacts with birth months not matching the current month according to the birth month and the birth day.

15. The storage medium as claimed in claim 11, wherein the birth date of each contact in the contact list in recorded in a format of month/day.
